(19) United States
(12) Patent Application Publication
(10) Pub. No.: US 2026/0089774 A1
(43) Pub. Date: Mar. 26, 2026

(54) DYNAMIC AND FLEXIBLE RADIO FREQUENCY (RF) NODE PAIRING FOR DISTRIBUTED SENSING

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 19/111,952

(22) PCT Filed: Nov. 24, 2022
(86) PCT No.: PCT/CN2022/133943

§ 371 Date: Mar. 14, 2025

(51) Int. Cl. H04W 76/10; H04B 17/309; H04L 5/00; H04W 4/38

(52) U.S. Cl. CPC H04W 76/10; H04B 17/346; H04L 5/0051; H04W 4/38

(57) ABSTRACT

In some implementations, pairing of a first sensing node and a second sensing node for radio frequency (RF) sensing may be performed. To do so, the first sensing node may operates in a Tx detection mode in which the first sensing node: periodically transmits instances of a first reference signal (RS), and periodically attempts to receive instances of a second RS transmitted by the second sensing node. The first sensing node may, responsive to detecting a target with a received instance of the second RS transmitted by the second sensing node, transition operation from the Tx detection mode to a Tx tracking mode in which the first sensing node: periodically transmits instances of a third RS, and periodically attempts to receive additional instances of the second RS transmitted by the second sensing node.

### BACKGROUND

### 1. Field of Disclosure

The present disclosure relates generally to the field of radiofrequency (RF)-based sensing, or simply “RF sensing” in a wireless network such as a cellular network.

### 2. Description of Related Art

As the sophistication of cellular networks such as fourth-generation (4G) and fifth-generation (5G) cellular networks continues to increase, the functionality of such networks expands beyond mere data communication. Cellular networks can, for example, provide positioning functionality to determine a geographical location of a cellular mobile device (known as a “user equipment” (UE)) within a coverage region of the cellular network. Further, such networks are expanding into RF sensing to be able to detect the objects (including their location and speed) from reflections (or echoes) of RF signals reflecting from the objects. However, RF signals used for RF sensing are often transmitted in an inefficient way, leading to increased power usage and overhead.

### BRIEF SUMMARY

An example method of enabling pairing of a first sensing node and a second sensing node for radio frequency (RF) sensing, according to this disclosure, may comprise operating the first sensing node in a Tx detection mode in which the first sensing node periodically transmits instances of a first reference signal (RS), and periodically attempts to receive instances of a second RS transmitted by the second sensing node. The method also may comprise responsive to detecting a target with a received instance of the second RS transmitted by the second sensing node, transitioning operation of the first sensing node from the Tx detection mode to a Tx tracking mode in which the first sensing node: periodically transmits instances of a third RS, and periodically attempts to receive additional instances of the second RS transmitted by the second sensing node.

An example method of enabling pairing of a first sensing node and a second sensing node for radio frequency (RF) sensing, according to this disclosure, may comprise operating the second sensing node in an Rx detection mode in which the second sensing node periodically attempts to receive instances of a first reference signal (RS) transmitted by the first sensing node. The method also may comprise, responsive to detecting a target with a received instance of the first RS transmitted by the first sensing node, transitioning operation of the second sensing node from the Rx detection mode to an Rx tracking mode in which the second sensing node: periodically transmits instances of a second RS, and periodically attempts to receive instances of a third RS transmitted by the first sensing node.

An example first sensing node for radio frequency (RF) sensing, according to this disclosure, may comprise a transceiver, a memory, one or more processors communicatively coupled with the transceiver and the memory, wherein the one or more processors are configured to operate in a Tx detection mode in which the first sensing node: periodically transmits instances of a first reference signal (RS) via the transceiver, and periodically attempts to receive, via the transceiver, instances of a second RS transmitted by a second sensing node. The one or more processors further may be configured to, responsive to detecting a target with a received instance of the second RS transmitted by the second sensing node, transition operation from the Tx detection mode to a Tx tracking mode in which the first sensing node: periodically transmits instances of a third RS via the transceiver, and periodically attempts to receive, via the transceiver, additional instances of the second RS transmitted by the second sensing node.

An example second sensing node for radio frequency (RF) sensing, according to this disclosure, may comprise a transceiver, a memory, one or more processors communicatively coupled with the transceiver and the memory, wherein the one or more processors are configured to operate in an Rx detection mode in which the second sensing node periodically attempts to receive instances of a first reference signal (RS) transmitted by the first sensing node. The one or more processors further may be configured to, responsive to detecting a target with a received instance of the first RS transmitted by the first sensing node, transition operation from the Rx detection mode to an Rx tracking mode in which the second sensing node: periodically transmits instances of a second RS, and periodically attempts to receive instances of a third RS transmitted by the first sensing node.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is a diagram of a distributed sensing system, according to an embodiment.

FIG. 3 is a diagram illustrating an example of a procedure for pairing transmitting (Tx) and receiving (Rx) nodes, according to an embodiment.

FIG. 4 is a timing diagram illustrating functionality of an Rx node in the Rx detection mode of FIG. 4, according to an embodiment.

FIG. 5 is a timing diagram illustrating functionality of an Rx node that transitions from Rx detection mode to Rx tracking mode, according to an embodiment.

FIG. 6 is a timing diagram illustrating corresponding functionality that a Tx node may implement when an Rx node implements the functionality of FIG. 5, according to an embodiment.

FIG. 7 is a timing diagram illustrating example functionality of a Tx node a Tx detection mode, according to an embodiment.

FIG. 8 is a timing diagram illustrating example functionality of a Tx node in circumstances in which it detects an RS transmission from an Rx node, but does not detect the target, according to an embodiment.

FIG. 9 is a flow diagram of a method of enabling pairing of a first sensing node and a second sensing node for RF sensing, according to an embodiment.

FIG. 10 is a flow diagram of another method of enabling pairing of a first sensing node and a second sensing node for RF sensing, according to an embodiment.

FIG. 11 is a block diagram of an embodiment of a sensing node.

FIG. 12 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IOT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “positioning reference signals,” “reference signals for positioning,” and the like may be used to refer to signals used for positioning of a mobile device, such as a user equipment (UE) in a 5G new radio (NR) network. As described in more detail herein, such signals may comprise any of a variety of signal types but may not necessarily be limited to a Positioning Reference Signal (PRS) as defined in relevant wireless standards. Additionally, unless otherwise specified, references to “sensing reference signals,” “reference signals for sensing,” and the like may be used to refer to signals used for RF sensing (also generically referred to herein as “sensing”) as described herein. A signal used for RF sensing and/or positioning may be generally referred to herein as a reference signal (RS). As described in more detail herein, such signals may comprise any of a variety of signal types but may not necessarily be limited to signals solely used for RF sensing.

As previously noted, RF sensing is being contemplated for use in various applications, including wireless networks such as cellular networks. However, techniques this far have contemplated using “always on” RF signals and/or signals transmitted and received by all RF sensing nodes without regard to the location of the target. This can lead to unnecessary overhead, inefficient use of energy/RF resources, sensing nodes, and the like. Embodiments herein address these and other user issues by providing a sensing scheme for pairing sensing nodes in a manner that may be implemented in a distributed sensing system, which can provide for efficient use of sensing nodes and RF resources, and/or other such advantages. Additional details will be provided after a review of applicable technology.

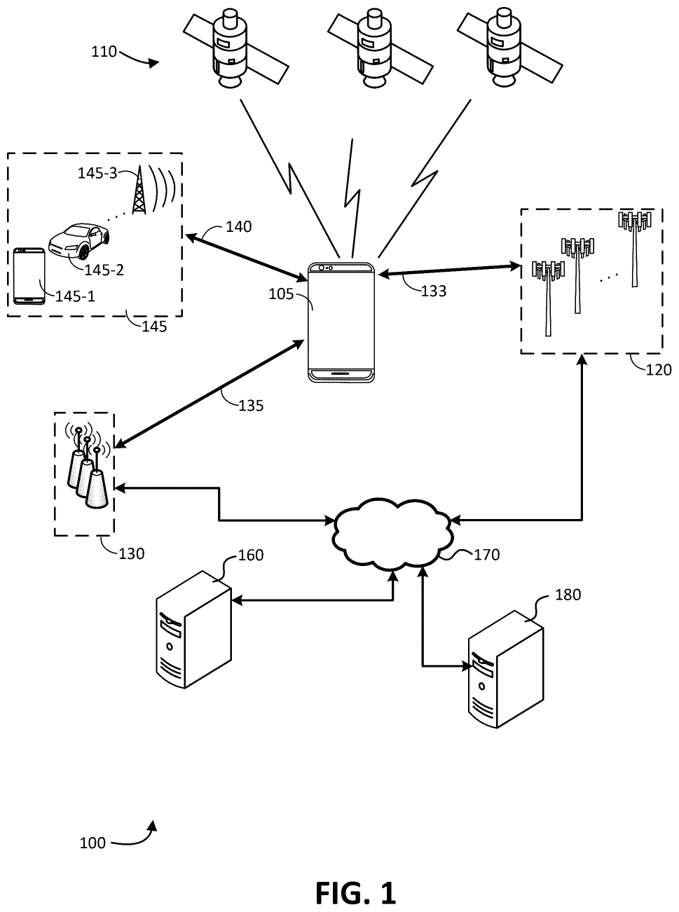

FIG. 1 is a simplified illustration of a wireless system capable of communication, positioning, and sensing, referred to herein as a “communication/positioning/sensing system” 100 in which a mobile device 105, network function server 160, and/or other components of the communication/positioning/sensing system 100 can use the techniques provided herein for pairing RF sensing nodes, according to an embodiment. (That said, embodiments are not necessarily limited to such a system.) The techniques described herein may be implemented by one or more components of the communication/positioning/sensing system 100. The communication/positioning/sensing system 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning/sensing system 100 may be capable of enabling communication between the mobile device 105 and other devices, positioning of the mobile device 105 and/or other devices, performing RF sensing by the mobile device 105 and/or other devices, or a combination thereof. For example, the communication/positioning/sensing system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning/sensing system 100. Similarly, the communication/positioning/sensing system 100 may include a larger or smaller number of base stations 120 and/or APs 130 than illustrated in FIG. 1. The illustrated connections that connect the various components in the communication/positioning/sensing system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions, and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an OFDM waveform to allow both RF sensing and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning/sensing system 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSS)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As noted, RF devices may enable a system such as the communication/positioning/sensing system 100 to perform RF sensing. In particular, multiple RF devices can be distributed over an area or region to identify objects, or “targets,” within the area or region. Type of distributed sensing system can be helpful to detect small targets, while effectively increasing the coverage and avoiding blind points. Moreover, distributed sensing may provide spatial resilience for target detection and tracking compared to traditional sensing.

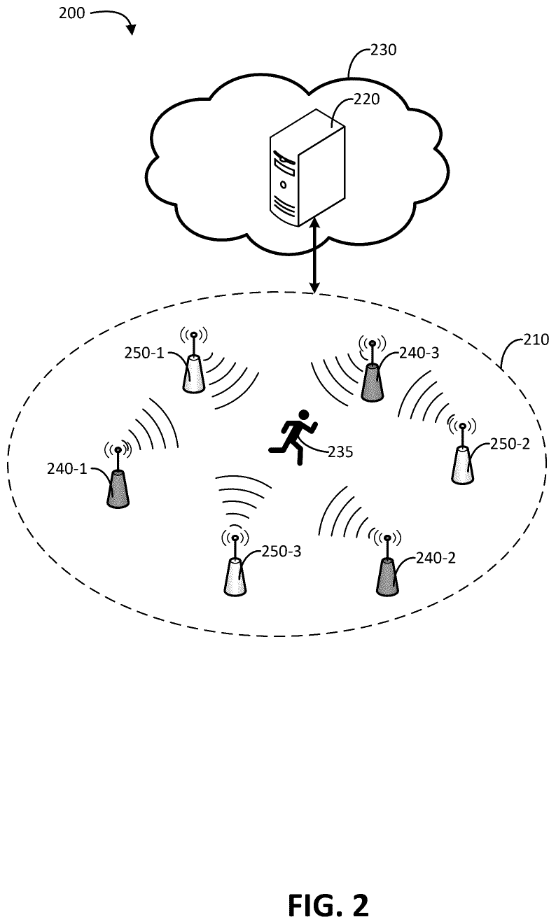

FIG. 2 is a diagram of a distributed sensing system 200, according to an embodiment. The distributed sensing system 200 may be incorporated into a larger system (e.g., the communication/positioning/sensing system 100 of FIG. 1), in which case components of the distributed sensing system 200 may perform other functions (related to communication and/or positioning, for example). In the distributed sensing system 200, sensing nodes (which may respond with wireless RF devices of FIG. 1, including mobile device 105, base stations 120, APs 130, other devices 145, or the like) may be grouped to a cluster 210 used to provide sensing for a particular area and multiple clusters (not shown and FIG. 2) may be used to cover a larger region. The cluster may be controlled by a cluster head 220, which may comprise a server that is local to the cluster 210 and/or accessible via the cloud 230. (As such, in some embodiments, the cluster had 220 may correspond with server 160 of FIG. 1.) Different clusters may be managed by the same cluster head 220, or different respective cluster heads.

Put generally, the distributed sensing system 200 may sense a target 235 using sensing nodes in the cluster 210. These sensing nodes may be paired by the cluster head 220, into transmitting (Tx) nodes 240 and receiving (Rx) nodes 250 or bistatic and/or multi-static sensing.

Within the cluster 210, the cluster head 220 can dynamically pair sensing nodes to efficiently detect and track the target 235. In the example of FIG. 2, there are six sensing nodes in the cluster 210: three Tx nodes 240 and three Rx nodes 250. As the target 235 moves through the area covered by the cluster 210, the cluster head 220 can provide centralized management, activating and deactivating different sensing nodes to detect and track the target 235. For example, the cluster head 220 can schedule times at which one or more of the Tx nodes 240 transmit RS and one or more of the Rx nodes 250 detect transmitted RS (times at which Rx nodes detect transmitted RS may be referred to herein as RS “estimation”), including reflections of the RS from the target 235 (thereby detecting the target 235). The one or more Rx nodes 250 can then report the status of detection back to the cluster head 220. From an initial detection (which may involve all sensing nodes in some instances), the cluster head can then determine effective node pairs from among the sensing nodes for target detection. In the example of FIG. 2, for instance, the cluster head 220 may analyze detection results from Rx nodes 250-1, 250-2, and 250-3 regarding RS transmitted by Tx nodes 240-1, 240-2, and 240-3 to determine that two pairs of sensing nodes can effectively detect and further track the target 235: Tx node 240-3/Rx node 250-1, and Tx node 240-3/Rx node 250-3. (Note that Tx node 240-3 is included in both pairs. However, depending on detection results, any combination of Tx nodes 240 and Rx nodes 250 may be paired or further tracking of the target 235.)

Other embodiments may vary from the example described in FIG. 2. For example, in some embodiments, rather than detecting the target by the Rx nodes 250, the Rx nodes may simply provide sensing data to the cluster head 220, which may then analyze the sensing data to determine the presence of the target 235. Further, it can be noted that, if capable, sensing nodes may perform beamforming (e.g., as suggested in FIG. 2) transmit and/or receive RS in a particular direction. That said, other embodiments may not utilize beamforming. Additional alternative variations may be implemented, depending on desired functionality.

In addition to providing coverage over a potentially large area, distributed sensing can provide other benefits. When compared with monostatic sensing, for example, distributed sensing can be easier to implement. For example, monostatic sensing generally requires the full-duplex operations, which the Tx and Rx are processed simultaneously in one device. Further, Monostatic sensing can require a larger power consumption, because the RS experiences bi-directional propagation loss. The other hand, and distribute it sensing, some nodes may be paired to perform bistatic and/or multistatic sensing, where nodes may be divided into Tx nodes and Rx nodes (e.g., shown in FIG. 2). In this case, the signals a only needs to propagate in one direction (from Tx to Rx), and thus the power consumption can be much less than the monostatic sensing for the same coverage. Put differently, for the power setting and requirement, distributed sensing with Tx and Rx nodes can roughly cover twice the area that monostatic nodes could. Moreover, Tx and Rx nodes do not need to have full-duplex capability. In fact, half-duplex nodes (e.g., nodes that an operate either as a Tx node or an Rx node) may not be needed. Instead, in some configurations, dedicated Tx or Rx nodes may be utilized. This can greatly reduce the amount of complexity (and cost) of nodes in a distributed sensing system.

It can be noted that, despite the discussion above that contrasts monostatic sensing with bistatic/multistatic sensing in a distributed system, some embodiments of a distributed system may employ monostatic sensing (e.g., in addition or as an alternative to bistatic/multistatic sensing).

Depending on desired functionality, distributed sensing may further utilize licensed and/or unlicensed RF bands. Compared to an un-licensed band, licensed band sensing can be helpful for the scalability of the sensing setting, given the relative efficiency of licensed RF band usage versus unlicensed band usage. According to some embodiments, to enable sensing service in an area, within the licensed band, the sensing nodes can be flexibly enabled or scheduled in short time. This can help ensure that there are enough nodes scheduled for the distributed sensing, including nodes in different clusters.

As discussed with regard to FIG. 2, in distributed sensing, not all nodes in a cluster may be helpful to detect a particular target. Some nodes may provide valuable target information while others provide nothing may provide interference. Thus, in traditional distributed sensing, the activating/deactivating of nodes and scheduling of RS transmission/estimation (e.g., by a cluster head) may impose a large resource cost accurately pair Tx and Rx nodes.

Traditional methods of distributed sensing may proceed as follows. First, in order to identify different Tx nodes, specific RS may be configured for each Tx node, and Rx node should detect all of the potential RS to identify the Tx node. Especially, when there are a large number of Tx nodes, Rx nodes we need to expend much effort to find out the effective RS from one pre-configured large RS set. This can be particularly burdensome when sensing is multiplexed with communication and sensing resources are limited. Second, a cluster head can collect the estimation results from all Rx nodes, even only part of the nodes can detect the sensing signals. Finally, head finally determines the effective Tx-Rx pair to detect the targets. In these traditional distributed sensing methods, information (signaling) exchanged between the cluster head and the nodes of a cluster can be relatively large, potentially intruding on communication resources. Moreover, in some scenarios scheduling by a cluster head may not be available, such as when communication capability is not enabled. In such instances, it can be hard to determine the effective pairs for the sensing.

Embodiments herein address these and other issues providing a low-cost over-the-air (OTA) procedure for pairing Tx and Rx nodes. This procedure can be widely used in distributed scenarios and can largely avoid the resource cost associated with communication between the sensing nodes and cluster head. Moreover, the procedure described herein can largely save the RS resources in Tx, and can largely reduce the estimation burden in the Rx.

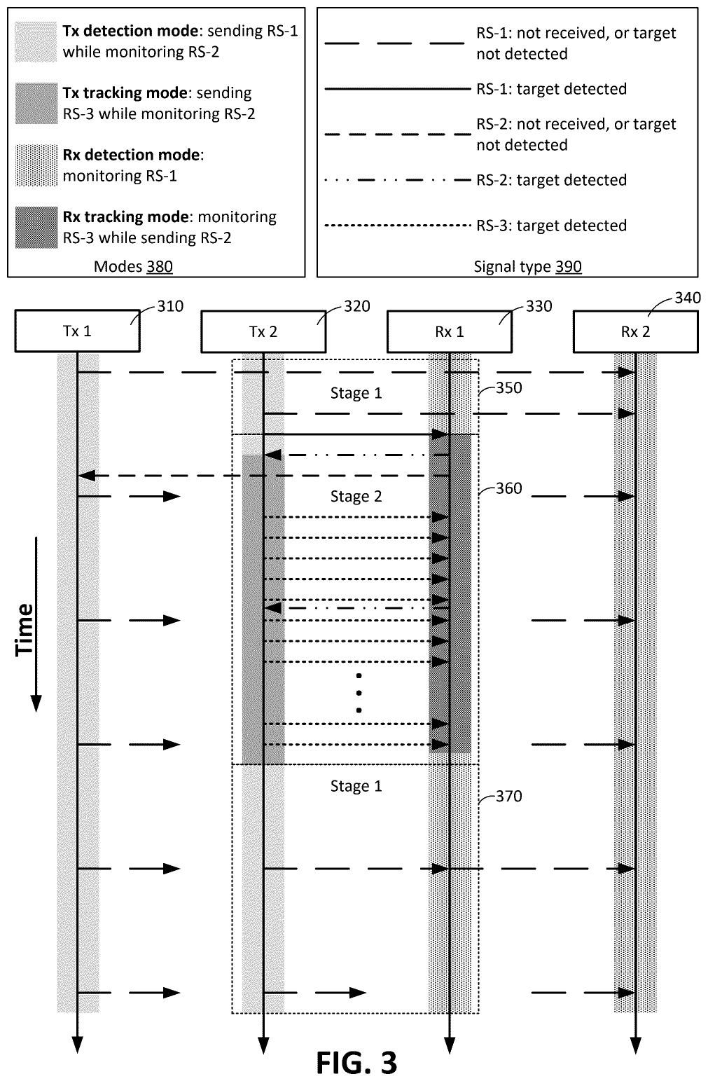

FIG. 3 is a diagram illustrating an example of a procedure for pairing Tx and Rx nodes, according to an embodiment. In this example, for sensing nodes are illustrated: first Tx 310, second Tx 320, first Rx 330, and second Rx 340. That said, a cluster may include more or fewer sensing nodes, depending on desired functionality. As shown in FIG. 3 and described in more detail hereafter, Tx and Rx nodes may implement detection and tracking modes, where detection is associated with “stage 1” (blocks 350 and 370 and FIG. 3) and tracking is associated with “stage 2” (block 360). When in detection mode, or stage 1, nodes may be considered “unpaired.” When in tracking mode, or stage 2, nodes may be considered “paired.”

In the example of FIG. 3, all nodes begin unpaired (at stage 1, block 350), and second Tx 320 and first Rx 330 become paired for a period of time (at stage 2, block 360), before reverting back to and unpaired state (stage 1, at block 370). As described in more detail hereafter with respect to subsequent figures, Tx nodes and Rx nodes may implement different functionality, or “loops,” when implementing different modes, to provide the functionality illustrated in FIG. 3. Each mode may involve transmitting or receiving instances of a certain RS. In embodiments herein, different RS are generically referred to as RS-1, RS-2, and RS-3, and are described in more detail hereafter. Modes and signal types are illustrated in FIG. 3 in boxes respectively labeled 380 and 390.

As illustrated, all nodes start in a detection mode and first Tx 310 and second Rx 340 remain unpaired. For second Rx 340, it remains in an Rx detection mode in which it monitors for instances of RS-1. Because the second Rx 340 (i) does not receive RS-1 or (ii) receives RS-1 with no detected target, it remains unpaired (in Rx detection mode) without changing modes. Similarly, for first Tx 310, it remains in a Tx detection mode in which it periodically transmits RS-1, while also monitoring for instances of RS-2. Because the first Tx 310 (i) does not receive RS-2, and/or (ii) receives RS-2 with no detected target, it remains unpaired (in Tx detection mode) without changing modes.

The procedure unfolds differently for the second Tx 320 and first Rx 330, which progress through stage 1 (block 350) to stage 2 (block 360), then back to stage 1 (block 370), as previously noted. In stage 1 (the “unpaired” stage), second Tx 320 and first Rx 330 are in the same detection modes as first Tx 310 and second Rx 340. That is, RS-1 is transmitted by Tx nodes in accordance with a predefined sparse resource pattern. According to some embodiments, all Tx nodes may transmit the same RS (e.g., RS-1), and all Rx nodes may be configured to detect that RS. Based on the pre-defined rules, Rx nodes may determine whether a target is detected in any received RS.

Second Tx 320 and first Rx 330 transition to stage 2 (block 360) when target is detected by the first Rx 330 with an RS-1 transmitted by second Tx 320. Upon receiving the RS-1 in which a target is detected, the first Rx 330 may then transition to a detection mode in which it monitors for RS-3 while sending RS-2. If second Tx 320 detects a target with the RS-2 sent by the first Rx 330, it may then transition to a tracking mode in which it sends RS-3 while continuing to monitor for RS-2. While second Tx 320 and Rx 330 are in these tracking modes, these nodes may be considered paired, and the procedure follows as indicated in stage 2 (block 360). In tracking mode, second Tx 320 may a transmit RS-3 more frequently than it transmitted RS-1 in stage 1, in order to accurately sense a detected target. In some embodiments, the transmission of RS-3 may be considered “dense,” and the transmission of RS-1 may be considered “sparse.” Second Tx 320 can remain in tracking mode and continue to send RS-3 until the target is no longer detected.

According to some embodiments, when the first Rx 330 longer detects a target, it may stop transmitting RS-2 and revert back to stage 1, in which first Rx 330 is no longer paired and operates in the Rx detection mode in which it monitors for RS-1. When the second Tx 320 determines that first Rx 330 has stopped transmitting RS-2 (e.g., the second Tx 320 has determined that a scheduled or expected RS-2 was not sent), it may also revert back to the Tx detection mode (stage 1, shown by block 370), sending RS-1 while monitoring for RS-2.

Channel reciprocity can help ensure that relevant Tx and Rx nodes are properly paired. That is, a target detected by first Rx 330 from RS-1 should also be detected by second Tx 320 from RS-2 (and subsequently detected by first Rx 330 from RS-3), due to channel reciprocity. Other nodes will not detect the target unless the target also affects the RF channel between a Tx and Rx node. Thus, the procedure and FIG. 3 has built-in efficiencies, pairing only relevant nodes that can detect a target. Further, nodes may transition to different modes automatically, without being scheduled or configured to do so by a central device such as cluster head or managing server. As such, the procedure in FIG. 3 can reduce overhead by reducing the amount of communication between sensing nodes and a central device.

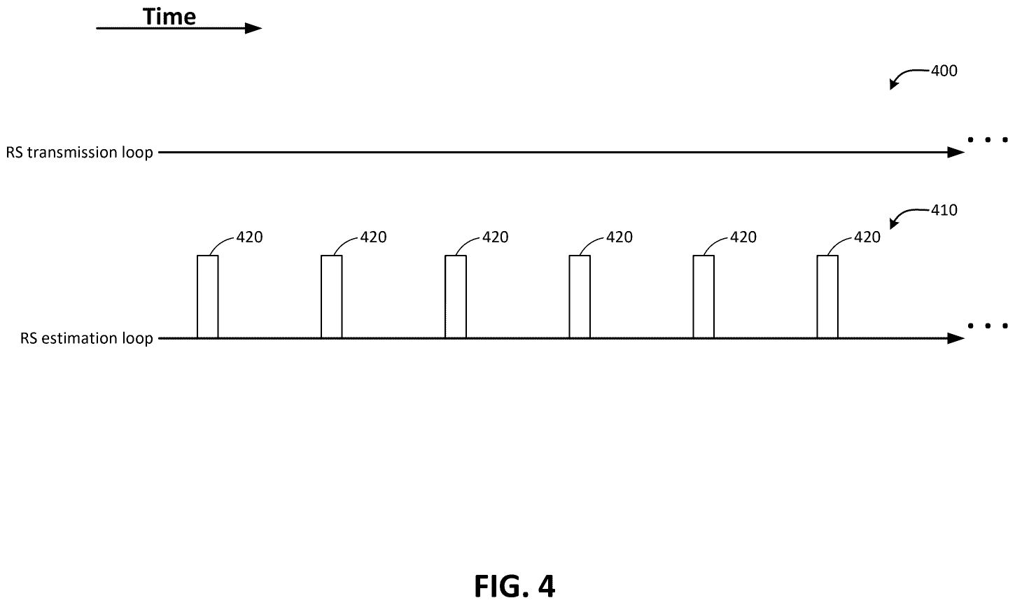

FIGS. 4-8 are diagrams illustrating functionality that can be executed by Tx and Rx nodes while in different modes, according to some embodiments. The execution of this functionality can lead to the pairing of nodes in the manner illustrated in the procedure of FIG. 3.

FIG. 4 is a timing diagram illustrating functionality of an Rx node in the Rx detection mode of FIG. 3 in which Rx nodes monitor for RS-1 while unpaired. Here, the functionality is illustrated as a pair of loops, comprising an RS transmission loop 400 and an RS estimation loop 410. The RS transmission loop 400 illustrates RS transmissions made by the Rx node. In this case, because no target has been detected, no RS transmissions are made. The RS estimation of 410 illustrates time windows 420 in which Rx node attempts to receive RS transmissions sent from one or more Tx nodes and determine whether a target is detected. Periodicity of time windows 420 may be predetermined (e.g., by a managing device, such as a cluster head), and may correspond with transmissions by one or more Tx nodes in the same cluster as the Rx node. Again, because no target has been detected, the periodicity may represent a predefined sparse pattern, to help preserve RF resources. Further, because no RS is received, and because no target is detected, the Rx node can continue to repeat the functionality illustrated in FIG. 4.

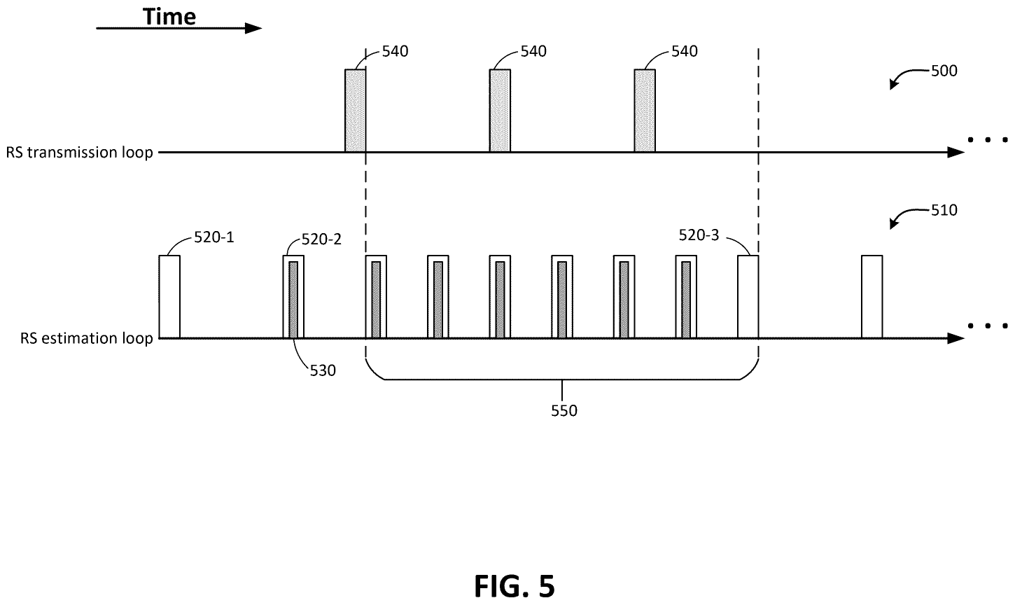

FIG. 5 is a timing diagram illustrating functionality of an Rx node that transitions from Rx detection mode to Rx tracking mode (e.g., during a second stage) after detecting a target. Here, the RS transmission loop 500 and RS estimation loop 510 may initially proceed in the manner illustrated in FIG. 4. Specifically, the Rx node initially operates in Rx detection mode in which the Rx node may not transmit RS, but instead may listen for RS transmissions by one or more Tx nodes during time windows 520. In this example, and RS transmission is not received first time window 520-1, but is later received at a second time window 520-2. The receipt of an RS transmission (e.g., RS-1 of FIG. 3) from one or more Tx nodes within an estimation window 520 and the detection of a target are represented by target detection blocks 530 within time windows 520. (To avoid clutter, many target detection blocks 530 and time windows 520 are not labeled in FIG. 5.) Upon detecting a target, the Rx node may then enter the Rx tracking mode in which it makes periodic RS transmissions 540 (e.g., RS-2 of FIG. 3) indicate to the Tx node that a target has been detected, and adjusts estimation windows 520 to detect additional RS transmissions (e.g., RS-3 of FIG. 3) from the Tx node during a time period 550 in which Rx and Tx nodes are paired. The timing and frequency of RS transmissions from the Tx node during the time period 550 (e.g., a dense detection pattern) may be predefined, such that the estimation time windows 520 of the Rx node match transmission times by the Tx node. The time period 550 may correspond to stage 2 of FIG. 3.

The time period 550 in which Rx and Tx nodes are paired may end when a target is no longer detected by the Rx node. In example of FIG. 5, the Rx node may not detect a target (or an RS transmission) a third time window 520-3, in which case the Rx node ceases periodic RS transmissions 540, which signals to the Tx noted that a target has no longer been detected. The Tx node then ceases the dense RS transmissions made in time period 550 and reverts back to a Tx detection mode in which it makes sparse transmissions for target detection. Additionally or alternatively, if the Tx node does not detect the periodic RS transmissions 540 of the Rx node, and/or does not detect a target on the periodic RS transmissions 540, the Tx node may cease dense RS transmissions and revert to Tx detection mode. This can signal to the Rx node that a target has no longer been detected and the Tx node is no longer in tracking mode. Upon reverting back to detection modes, the Rx node and Tx node may no longer be considered paired (but may be paired again if a target is subsequently detected).

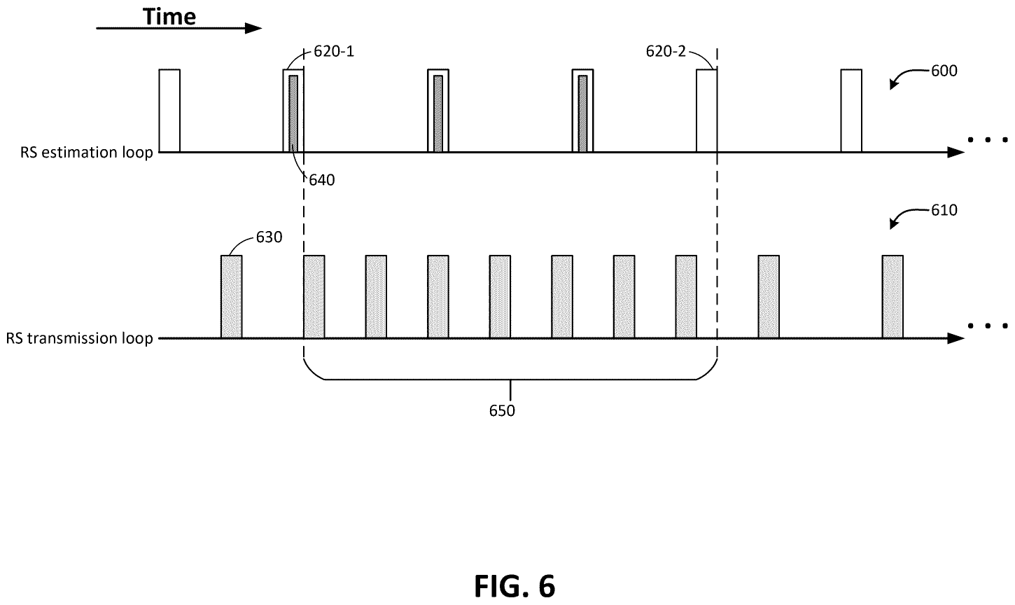

FIG. 6 is a timing diagram illustrating corresponding functionality that a Tx node may implement when an Rx node implements the functionality of FIG. 5. Similar to FIGS. 4 and 5, FIG. 6 includes an RS estimation loop 600 and RS transmission loop 610. (Note that, in contrast to FIGS. 4 and 5, the estimation loop 610 and FIG. 6 is at the top of the figure, and the transmission loop 610 is at the bottom of the figure.) As shown in the RS estimation loop 600, the Tx node may periodically listen for RS transmissions sent from an Rx node during time windows 620 (e.g., which again may take place in accordance with a predetermined transmission schedule). In particular, the Tx node may operate in a Tx detection mode in which it sends RS transmissions 630 (e.g., RS-1) and monitors for RS transmissions from one or more Rx nodes (e.g., RS-2) during time windows 620, corresponding to the functionality of second Tx 320 in stage 1 of FIG. 3. Target detection blocks 640 represent occasions in which the Tx node (i) receives an RS transmission from an Rx node and (ii) detects a target from the received transmission. (The first instance of block 640 in FIG. 6 may correspond to an RS transmission by an Rx node that detected the target in the first RS transmissions 630 by the Tx node.) As previously indicated, upon receiving the RS transmission from the Rx node and detecting a target from the received transmission, the Tx node may then enter into a Tx tracking mode (e.g., corresponding to stage 2, or a paired mode) or a period of time 650 in which the Tx node may make relatively dense RS transmissions to track the detected target. Nodes will remain in target detection modes until the target is longer detected. As previously indicated, if the Rx node no longer detects the target, it can stop RS transmissions. Otherwise, the Tx node may not detect the target from the Rx transmission. In either case, target a no longer the detected during a time window 620-2, in which case the Tx node can reverts to stage 1 in which it may transmit a sparse RS transmission pattern.

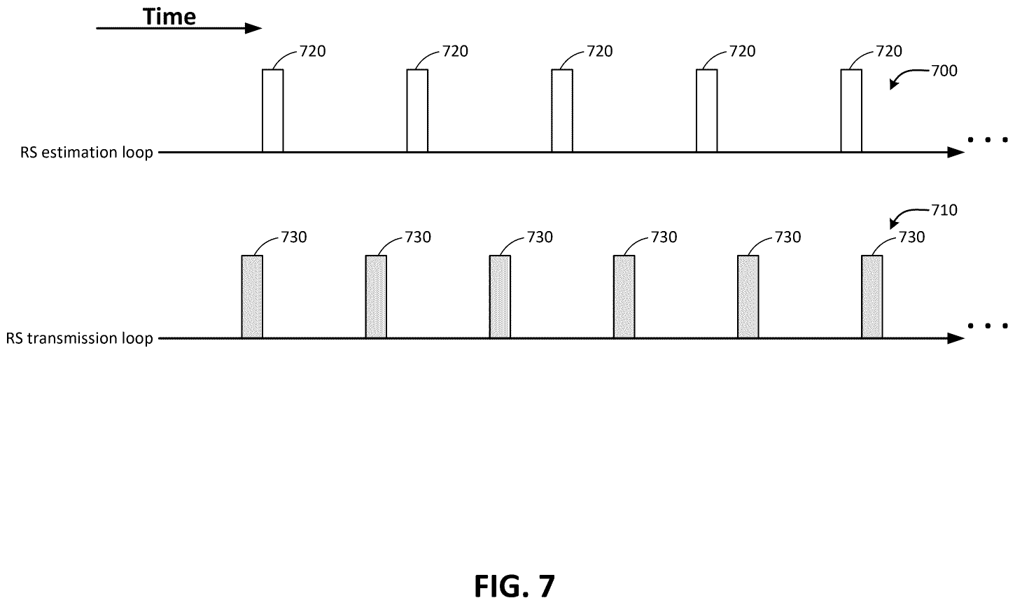

FIG. 7 is a timing diagram illustrating example functionality of a Tx node a Tx detection mode. Again, the functionality is illustrated as a pair of loops, comprising an RS estimation loop 700 and an RS transmission loop 710. Here, the RS estimation loop 700 comprises periodic time windows 720 during which the Tx node attempts to detect RS transmissions Rx nodes. Again, timing and periodicity of time windows 720 may be predetermined (e.g., by a managing device, such as a cluster head), and may correspond with transmissions by one or more Rx nodes in the same cluster as the Tx node. Additionally, the Tx node transmits a series of RS transmissions 730 or target detection by one or more Rx nodes. However, because no target his detected in the example of FIG. 7, no changes made to functionality. Again, the periodicity of RS transmissions 730 while in Tx detection may represent a predefined sparse pattern to help preserve RF resources.

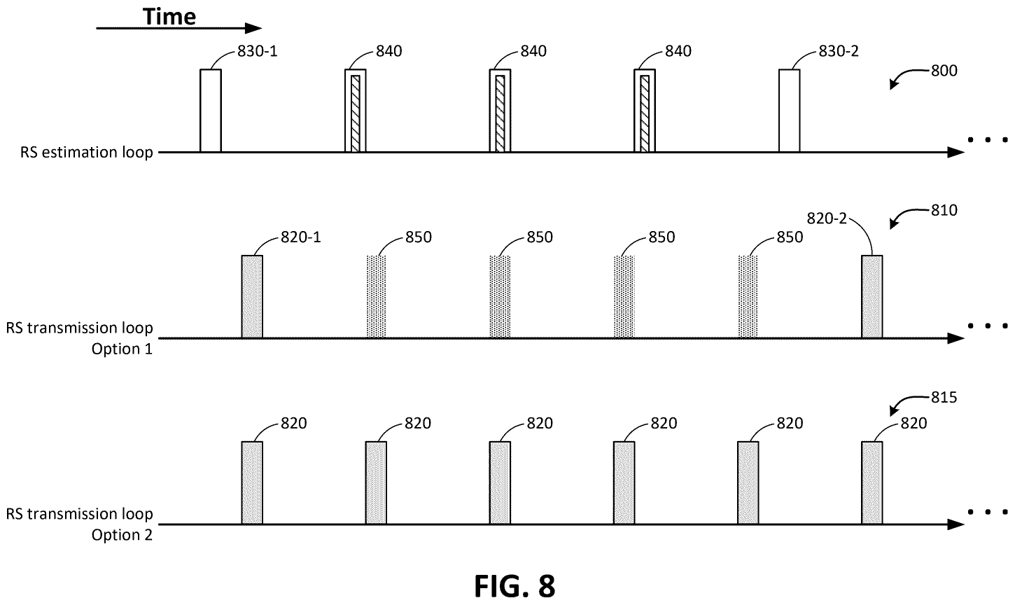

FIG. 8 is a timing diagram illustrating example functionality of a Tx node in circumstances in which it detects an RS transmission (e.g., RS-2) from an Rx node, but does not detect the target, according to some embodiments. In the example of FIG. 8 an RS estimation 800 loop is shown, and two options are shown for the RS transmission loop: a first RS transmission loop 810 corresponding to a first option, and a second RS transmission loop 815 corresponding to a second option. Although there may be channel reciprocity, a Tx node may not detect the target (detected by the Rx node) if RS transmissions sent by the Rx node (e.g., RS-2) cannot match predefined conditions, such as a threshold SNR.

In accordance with the first option, the Tx node may transmit RS transmissions 820 and perform estimation during time windows 830, in the manner described in the above-discussed embodiments with respect to the Tx detection mode. However, if the Tx node receives and RS transmission from an Rx node during one or more time windows, as shown by time windows 840, the Tx node may then cease to transmit RS transmissions 820. As shown in first RS transmission loop 810, times 850 are times at which the Tx node would send periodic RS transmissions 820, but does not. Instead, the Tx node refrains from transmitting the RS transmissions 820 until a target is detected (not shown) or an RS transmission is not received during an estimation window. If the RS transmission from an Rx node is not received during an estimation window, as shown at estimation window 830-2, the Tx node can then resume transmissions, as indicated by RS transmission 820-2. By refraining from RS transmission this in this manner, the Tx node can help save power and avoid potential RF interference with other paired nodes. Alternatively, as illustrated the second RS transmission loop 815, the Tx node may simply continue to transmit RS transmissions 820.

As described in the embodiments herein, different RS may be used for different purposes. Generally put, different RS (e.g., RS-1, RS-2, RS-3) may differ in timing/repetition, waveform, frequency, and/or other aspects that can enable a receiving node to distinguish between different RS. (As referred to herein, individual transmissions of an RS may be referred to as RS “transmissions” or “instances.”) Utilizing different RS for different purposes (e.g., as described herein with respect to RS-1, RS-2, and RS-3) can enable a receiving node to determine the mode (e.g., tracking or detecting) the transmitting node is in. According to some embodiments, all Tx nodes and Rx nodes utilize the same RS or the same function. For example, all Tx nodes in a cluster may transmit RS-1 for sensing in detection mode, all Rx nodes in a cluster may transmit RS-2 sensing in a tracking mode, and all Tx nodes in a cluster may transmit RS-3 for sensing in the tracking mode. It can be noted that, in a distributed sensing setting, most nodes are generally operating within the detection mode most of the time. The sharing of a common RS for all nodes can help reduce overhead (e.g., in signal processing).

Additionally or alternatively, embodiments may utilize certain RS (e.g., RS-2) to indicate target information from an Rx node to a Tx node read as such, the transmission of this RS (e.g., RS-2) could be much sparser than the RS used in the detection mode (e.g., RS-1). Further, the RS sent by the Rx node during tracking mode may not be specifically designed for accuracy (whereas the RS sent by the Tx nodes during tracking mode may be designed for accuracy). As such, implementation of the RS transmitted by the Rx node during tracking (e.g., RS-2) may be relaxed. For example, it may not be necessary to maintain phase continuity among adjacent RS signals transmitted by the Rx node during tracking.

According to some embodiments, the RS transmitted by the Tx node used for the sensing in the tracking mode (e.g., RS-3) may have a denser pattern (e.g., higher repetition rate) and/or wider bandwidth then other RS signals (e.g., RS-1 and RS-2). Some vitamins, the RS transmitted by the Tx node used for sensing in the tracking mode (e.g., RS-3) may comprise the same RS as the RS transmitted by the Tx node used for sensing in the detection mode (e.g., RS-1), but with a denser transmission pattern. By reusing this RS, it may avoid interference for the detection in the non-paired Rx nodes, with the trade-off that it may increase likelihood of interference for the paired nodes. Additionally or alternatively, the RS transmitted by the Tx node in the tracking mode (e.g., RS-3) may be a specific of RS used for sensing in the tracking mode. By using a specific RS in this manner, paired nodes can avoid potential interference from other non-paired nodes.

According to some embodiments, the RS transmitted by the Tx node during detection (e.g., RS-1) and the RS transmitted by the Rx node during tracking (e.g., RS-2) may comprise the same RS, or could be selected from one pre-defined common RS pool. For example, if all the Tx nodes (e.g., in a cluster) reuse the same RS-1, an Rx node may receive multiple RS-1 from different Tx nodes. Although this may increase a likelihood of interference, the cost of reusing RS-1 is low because the search space is small (the pool size is just 1). In contrast, by using a pre-defined RS pool, each node may randomly pick an RS with different seeds/periodicity. Although such pool can reduce the interference level, it increases search cost. With these trade-offs in mind, it may be desirable to reuse the same RS-1 in a sparse distributed setting where the likelihood of interference is low.

With regard to utilizing a common RS pool, two types of RS pools may be considered. One type is one RS pool with small size, which is used for the sparse distributed sensing scenario. This can help reduce searching costs and can be used for a sparse distributed sensing scenario in which the likelihood of interference is low (e.g., at any given time only limited number of nodes within RF sensing range may be scheduled for sensing). Another type of RS pool is in our school with a relatively large size which can be used for dense distributed sensing (e.g., at any given time a relatively large number of nodes within RF sensing range may be scheduled for sensing). The use of a larger pool in a dense distributed sensing scenario can help reduce the likelihood of interference. However, as noted, this increases the search space and thus the processing cost.

As noted, the use of common RS may make it unclear to a receiving node about which node transmitted the RS. For example, a Tx/Rx node may not know which node it is paired with and may be paired with multiple nodes. For example, in the embodiments described previously, all of the Tx nodes that can detect RS-2 are paired, and all of the Rx nodes that can detect RS-3 are paired. Moreover, as also described herein must nodes remain paired until a target is out of coverage (or is otherwise no longer detected). Despite the fact that nodes may not know the identity of or more nodes with which they are paired, sensing can still be determined using a centralized device (e.g., the cluster head 220 FIG. 2). That is, each node can report sensing data to a server, which can use the reported data and known information regarding the nodes (e.g., respective locations of each node, scheduled to transmission times, etc.) to determine information regarding a detected target (e.g., location, Doppler, etc. of the target).

Depending on desired functionality, the sensing data obtained by sensing nodes and provided to a server for detecting targets may vary. According to some embodiments, sensing data may include range, SNR, and/or Doppler information regarding each of one or more detected targets. Sensing data can be used to determine information regarding a target such as location, shape, velocity, or a combination thereof. According to some embodiments, predefined sensing rules may be configured to enable one or more services, such as identifying a target of interest. For example, for pedestrian detection, certain rules regarding speed may be used to filter out vehicles. When there is a target with speed 70 km/h, it can be assumed not to be a pedestrian and may be ignored. Thus, rules may be defined to identify desired targets within received signals. Moreover, sensing settings (e.g., RS periodicity, range, etc.) may be established to ensure proper sensing is performed to implement any predefined sensing rules. According to some embodiments, based predefined rules provided to an Rx node by a server, Rx node may determine whether there is target of interest or not.

As discussed with respect to FIGS. 3-8, both Tx and Rx sensing nodes may transmit and receive RS for sensing. For example, in a Tx detection mode, a Tx node transmits the RS-1 and monitors for RS-2. Further, in an Rx detection mode, and Rx node monitors for RS-3 and transmits RS-2. Such, each node may be half duplex (e.g., performing time division duplex (TDD)), or may be full-duplex (capable of transmitting and receiving at the same time). However, in some distributed sensing settings, low-tier (e.g., low-cost) nodes may be utilized in which nodes have either transmission or reception capability, but not both. In such embodiments, a hybrid approach may be used where low-tier nodes having only transmission or reception capability may be paired with other nodes with complementary functionality. For example, or Rx nodes with only detection capability, an adjacent high-tier (e.g., half duplex or full duplex) Rx node can be used to assist the RS-2 transmission during Rx tracking mode. Likewise, for Tx nodes with only transmission capability, an adjacent high-tier Tx node can assist the RS-2 reception.

In such embodiments, high tier nodes may be reused to provide additional sensing capabilities. As an example, if a first Tx node (e.g., low-tier node) has only transmission capability and a nearby second Tx node e.g., a high-tier node) has transmission and reception capabilities, the second Tx node can assist the first Tx node or RS-2 reception. In this example, the two nodes may be connected by a wired connection (e.g., to facilitate communication between the two nodes without using wireless resources). A similar implementation may be made utilizing Rx nodes.

Further, according to some embodiments, if one low-tier node has only transmission capability and another low-tier node has only reception capability, they may be utilized as a single high-tier node (e.g., either an Rx node or Tx) having transmission and reception capability. Such utilization may be on an as-needed basis. For example, if a reception-only Rx node in detection mode needs to transition to a tracking mode (in which it needs to transmit RS-2), the nearby transmission-only node may be configured (e.g., on-the-fly, when the transition is made) to transmit the RS-2.

According to some embodiments, additional signaling may be performed once Tx and Rx nodes have been paired. For example, the paired Tx and Rx nodes may report sensing data comprising estimation results of received RS-2 and RS-3 to a server (e.g., a cluster head). By reporting information at the same time, paired nodes may help reduce the likelihood of a false alarm (e.g., false detection of a target). Moreover, this type of coordinated reporting can also be used to jointly determine the location of the target.

Depending on desired functionality, the content and formatting of the reporting of sensing data to a server may vary. For example, according to some embodiments, reporting of sensing data by a sensing node may include indication of whether the sensing node is paired or not (e.g., a single-bit indication), information regarding a detected target (e.g., range, signal strength of the target, doppler information, or a combination thereof). This information together with joint reporting of paired nodes can further help reduce false alarms and determine the location of a target. For example, if the estimated signal strength is very low and only 1 or 2 nodes in a relatively dense cluster detects the target, the cluster head may consider the detection of the target as a false alarm. Further, localization of a target any possible with as few as two nodes, with an indication of the beams used for sensing (e.g., angular information, in addition to range information).

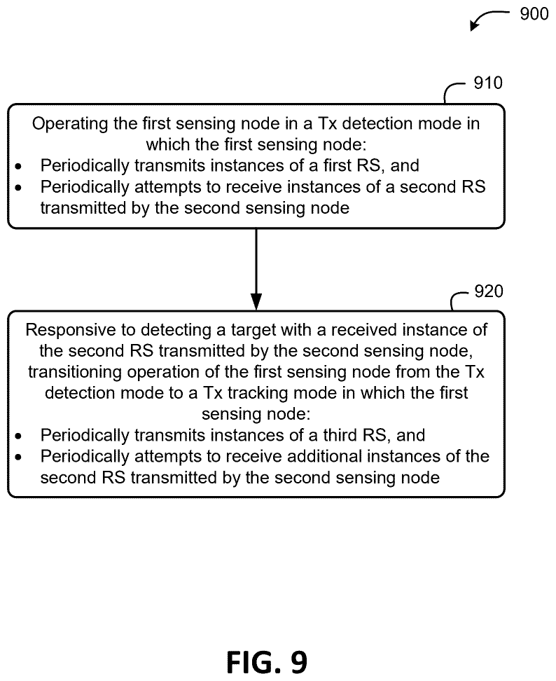

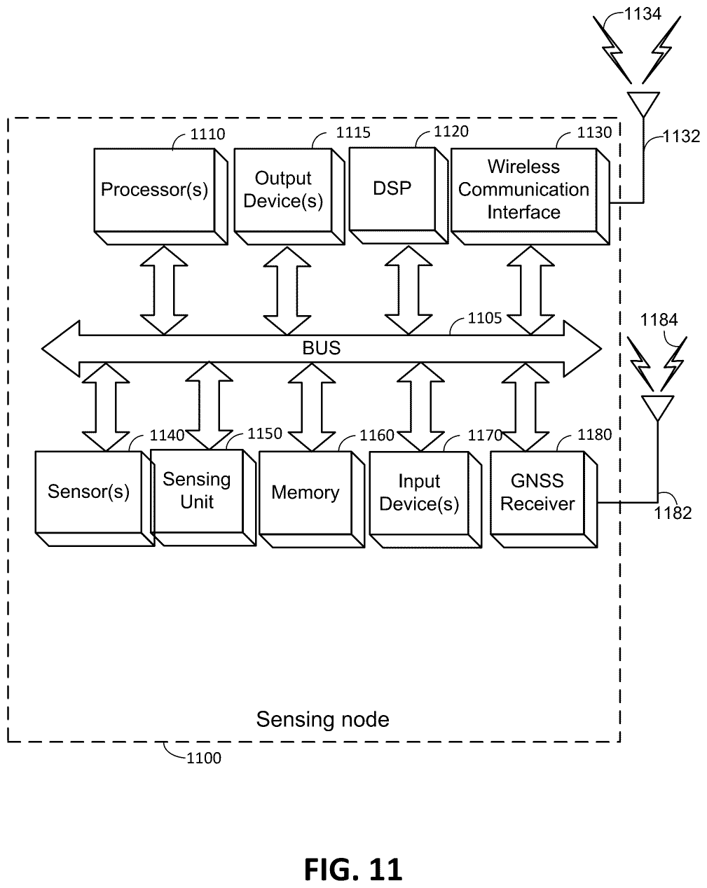

FIG. 9 is a flow diagram of a method 900 of enabling pairing of a first sensing node and a second sensing node for RF sensing, according to an embodiment. The functions illustrated in the blocks of FIG. 9 may be performed, for example, by a Tx node as described herein. Structure/means for performing the functionality illustrated in one or more of the blocks shown in FIG. 9 may be performed by hardware and/or software components of a sensing node. Example components of a sensing node are illustrated in FIG. 11, which is described in more detail below.

At block 910, the functionality comprises operating the first sensing node in a Tx detection mode in which the first sensing node: periodically transmits instances of a first RS, and periodically attempts to receive instances of a second RS transmitted by the second sensing node. As illustrated in FIG. 7, for example, a Tx node may periodically transmit (RS transmission loop 710) and periodically attempt to receive (RS estimation loop 700) RS to detect an object. According to some embodiments, the first sensing node may periodically transmit the instances of the first RS in the Tx tracking mode at a higher repetition rate than a repetition rate at which the first sensing node periodically attempts to receive the instances of the second RS transmitted by the second sensing node. Additionally or alternatively, the first RS and the second RS may be selected from a common RS pool.

Structure/means for performing functionality at block 910 may comprise a bus 1105, processor(s) 1110, digital signal processor (DSP) 1120, wireless communication interface 1130, sensing unit 1150, memory 1160, or other components of a sensing node 1100, or any combination thereof. Such components are illustrated in FIG. 11 and described hereafter.

At block 920, the functionality comprises, responsive to detecting a target with a received instance of the second RS transmitted by the second sensing node, transitioning operation of the first sensing node from the Tx detection mode to a Tx tracking mode in which the first sensing node: periodically transmits instances of a third RS, and periodically attempts to receive additional instances of the second RS transmitted by the second sensing node. As illustrated with respect to FIG. 6, transmission of a third RS may be more frequent than transmission of the first and/or second RS. As such, according to some embodiments of the method 900, the first sensing node may periodically transmit the instances of the third RS in the Tx tracking mode at a higher repetition rate than a repetition rate at which the first sensing node periodically transmits the instances of the first RS in the Tx detection mode.

Structure/means for performing functionality at block 920 may comprise a bus 1105, processor(s) 1110, digital signal processor (DSP) 1120, wireless communication interface 1130, sensing unit 1150, memory 1160, or other components of a sensing node 1100, or any combination thereof. Such components are illustrated in FIG. 11 and described hereafter.

As noted in the previously described embodiments, embodiments may include additional features, depending on desired functionality. For example, RS transmission may be predetermined (e.g., obtained from a predetermined or preestablished resource pool). Thus, according to some embodiments, the periodic transmission of the instances of the first RS, the periodic attempted reception of the instances of the second RS, the periodic transmission of the instances of the third RS, or any combination thereof, may be in accordance with a configuration received by the first sensing node from a server.

Further, as noted, sensing nodes may transition back to a detection mode from a tracking mode when an object is no longer detected. For example, some embodiments of the method 900 may further comprise transitioning the operation of the first sensing node from the Tx tracking mode back to the Tx detection mode, wherein transitioning the operation of the first sensing node back to the Tx detection mode is responsive to: the first sensing node not detecting the target with a received additional instance of the second RS transmitted by the second sensing node, or the first sensing node not receiving an additional instance of the second RS transmitted by the second sensing node. Or, in some embodiments, the first sensing node not detecting the target with the received second RS. That said, as described with respect to FIG. 8, embodiments may respond differently if a target is not detected in one or more instances of the second RS. For example, according to some embodiments, responsive to receiving a particular instance of the second RS transmitted by the second sensing node without detecting the target with the particular instance of the second RS, the first sensing node pauses the periodic transmission of the instances of the first RS while operating in the Tx detection mode. That said, according to some embodiments, the first sensing node may simply continue to perform the periodic transfer of the instances of the first RS.

Embodiments may further include performing sensing. Some embodiments include, for example, obtaining sensing data from the received instance of the second RS transmitted by the second sensing node and sending the sensing data from the first sensing node to a server. In such embodiments, the sensing data may further comprise information indicative of: a range between the target and the first sensing node, a signal-to-noise ratio (SNR) of the received instance of the second RS transmitted by the second sensing node, Doppler information regarding the target, or any combination thereof.

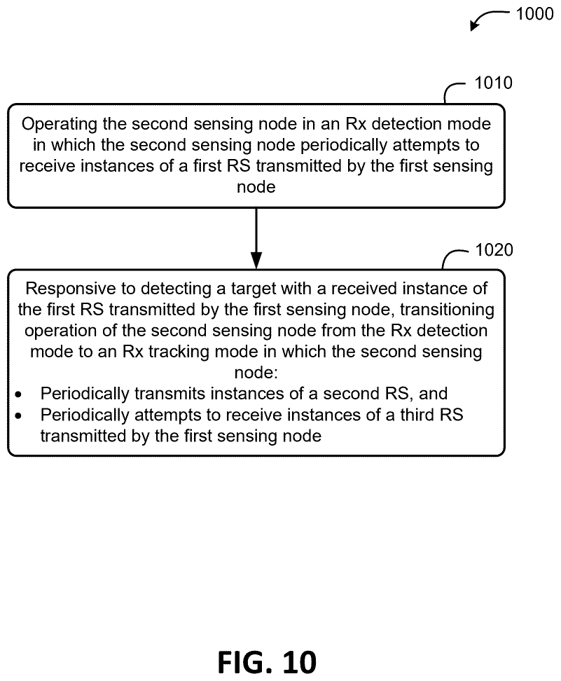

FIG. 10 is a flow diagram of another method 1000 of enabling pairing of a first sensing node and a second sensing node for RF sensing, according to an embodiment. The functions illustrated in the blocks of FIG. 10 may be performed, for example, by an Rx node as described herein. Structure/means for performing the functionality illustrated in one or more of the blocks shown in FIG. 10 may be performed by hardware and/or software components of a sensing node. Example components of a sensing node are illustrated in FIG. 11, which is described in more detail below.

At block 1010, the functionality comprises operating the second sensing node in an Rx detection mode in which the second sensing node periodically attempts to receive instances of a first RS transmitted by the first sensing node. An example of Rx detection mode is illustrated in FIG. 4, discussed previously. Structure/means for performing functionality at block 1010 may comprise a bus 1105, processor(s) 1110, digital signal processor (DSP) 1120, wireless communication interface 1130, sensing unit 1150, memory 1160, or other components of a sensing node 1100, or any combination thereof. Such components are illustrated in FIG. 11 and described hereafter.

At block 1020, the functionality comprises, responsive to detecting a target with a received instance of the first RS transmitted by the first sensing node, transitioning operation of the second sensing node from the Rx detection mode to an Rx tracking mode in which the second sensing node: periodically transmits instances of a second RS, and periodically attempts to receive instances of a third RS transmitted by the first sensing node. An example of a transition from Rx detection mode to Rx tracking mode is provided in FIG. 5. Structure/means for performing functionality at block 1020 may comprise a bus 1105, processor(s) 1110, digital signal processor (DSP) 1120, wireless communication interface 1130, sensing unit 1150, memory 1160, or other components of a sensing node 1100, or any combination thereof. Such components are illustrated in FIG. 11 and described hereafter.

As noted in the previously described embodiments, embodiments may include additional features, depending on desired functionality. For example, the periodic attempted reception of the instances of the first RS transmitted by the first sensing node, the periodic transmission of the instances of the third RS, the periodic attempted reception of the instances of the third RS transmitted by the first sensing node, or any combination thereof, may be in accordance with a configuration received by the second sensing node from a server. In some embodiments, the method 1000 may further comprise transitioning the operation of the second sensing node from the Rx tracking mode back to the Rx detection mode, wherein transitioning the operation of the first sensing node back to the Rx detection mode is responsive to: the second sensing node not detecting the target with a received instance of the third RS transmitted by the first sensing node, or the second sensing node not receiving an instance of the third RS transmitted by the first sensing node.

As explained elsewhere herein, the repetition rates of various RS may reflect desired functionality. According to some embodiments, the second sensing node may periodically attempt to receive the instances of the third RS transmitted by the first sensing node at a higher repetition rate than a repetition rate at which the second sensing node periodically attempts to receive the instances of the first RS transmitted by the first sensing node. Additionally or alternatively, with the second sensing node may periodically attempt to receive the instances of the first RS transmitted by the first sensing node at a higher repetition rate than a repetition rate at which the first sensing node periodically transmits the instances of the second RS. oaring to some embodiments, the first RS and the second RS are selected from a common RS pool.

Again, data may be sent to a server to perform and/or process the sensing. According to some embodiments, the method 1000 may further comprise obtaining sensing data from a received instance of the third RS transmitted by the first sensing node, and sending the sensing data from the second sensing node to a server. In such embodiments, the sensing data may further comprise information indicative of: a range between the target and the second sensing node, a signal-to-noise ratio (SNR) of the received instance of the third RS transmitted by the first sensing node, Doppler information regarding the target, or any combination thereof.

FIG. 11 is a block diagram of an embodiment of a sensing node 1100, which can be utilized as described herein (e.g., in association with the previously described figures), for performing RF sensing. In some embodiments, for example, the sensing node 1100 may comprise, for example, a mobile (e.g., movable/portable) device (e.g., UE, tablet, laptop, vehicle, etc.). In some embodiments, the sensing node 1100 may comprise a fixed (e.g., immobile) electronic device. It should be noted that FIG. 11 is meant only to provide a generalized illustration of various components, any or all of which may be utilized as appropriate. Furthermore, the functionality of the sensing nodes discussed herein may be executed by one or more of the hardware and/or software components illustrated in FIG. 11.

The sensing node 1100 is shown comprising hardware elements that can be electrically coupled via a bus 1105 (or may otherwise be in communication, as appropriate). The hardware elements may include a processor(s) 1110 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1110 may comprise one or more processing units, which may be housed in a single integrated circuit (IC) or multiple ICs. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below). The sensing node 1100 also can include one or more input devices 1170, which can include without limitation one or more keyboards, touch screens, touch pads, microphones, buttons, dials, switches, and/or the like; and one or more output devices 1115, which can include without limitation one or more displays (e.g., touch screens), light emitting diodes (LEDs), speakers, and/or the like.

The sensing node 1100 may also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the sensing node 1100 to communicate with other devices as described in the embodiments above. The wireless communication interface 1130 may permit data and signaling to be communicated (e.g., transmitted and received) with base stations of a network, for example, via eNBs, gNBs, ng-eNBs, access points, various base stations and/or other access node types, and/or other network components, computer systems, and/or any other electronic devices communicatively coupled with base stations, as described herein. The communication can be carried out via one or more wireless communication antenna(s) 1132 that send and/or receive wireless signals 1134. According to some embodiments, the wireless communication antenna(s) 1132 may comprise a plurality of discrete antennas, antenna arrays, or any combination thereof. The antenna(s) 1132 may be capable of transmitting and receiving wireless signals using beams (e.g., Tx beams and Rx beams). Beam formation may be performed using digital and/or analog beam formation techniques, with respective digital and/or analog circuitry. The wireless communication interface 1130 may include such circuitry.

Depending on desired functionality, the wireless communication interface 1130 may comprise a separate receiver and transmitter, or any combination of transceivers, transmitters, and/or receivers to communicate with base stations (e.g., ng-eNBs and gNBs) and other terrestrial transceivers, such as wireless devices and access points. The sensing node 1100 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The sensing node 1100 can further include sensor(s) 1140. Sensor(s) 1140 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the sensing node 1100 may further comprise a sensing unit 1150. The sensing unit 1150 may comprise hardware and/or software components capable of transmitting and/or receiving RF signals (e.g., RS) to detect one or more targets in the manner described herein. The sensing unit 1150 may comprise a standalone component connected with a bus 1105, as illustrated, or may be incorporated into another component (e.g., the wireless indication interface 1130). Further, the sensing unit 1150 may be communicatively coupled with an antenna 1132, which it may share with the wireless communication interface 1130. Additionally or alternatively, the sensing unit 1150 may have its own antenna (not shown). In some embodiments the sensing unit 1150 may be communicatively coupled with multiple antennas or an antenna array capable of sending and/or receiving RF signals via directional beams.

Embodiments of the sensing node 1100 may also include a Global Navigation Satellite System (GNSS) receiver 1180 capable of receiving signals 1184 from one or more GNSS satellites using an antenna 1182 (which could be the same as antenna 1132). Positioning based on GNSS signal measurement can be utilized to complement and/or incorporate the techniques described herein. The GNSS receiver 1180 can extract a position of the sensing node 1100, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1180 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1180 is illustrated in FIG. 11 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1110, DSP 1120, and/or a processor within the wireless communication interface 1130 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 1110 or DSP 1120.

The sensing node 1100 may further include and/or be in communication with a memory 1160. The memory 1160 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1160 of the sensing node 1100 also can comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the sensing node 1100 (and/or processor(s) 1110 or DSP 1120 within sensing node 1100). In some embodiments, then, such code and/or instructions can be used to configure and/or adapt a general-purpose computer (or other device) to perform one or more operations in accordance with the described methods.

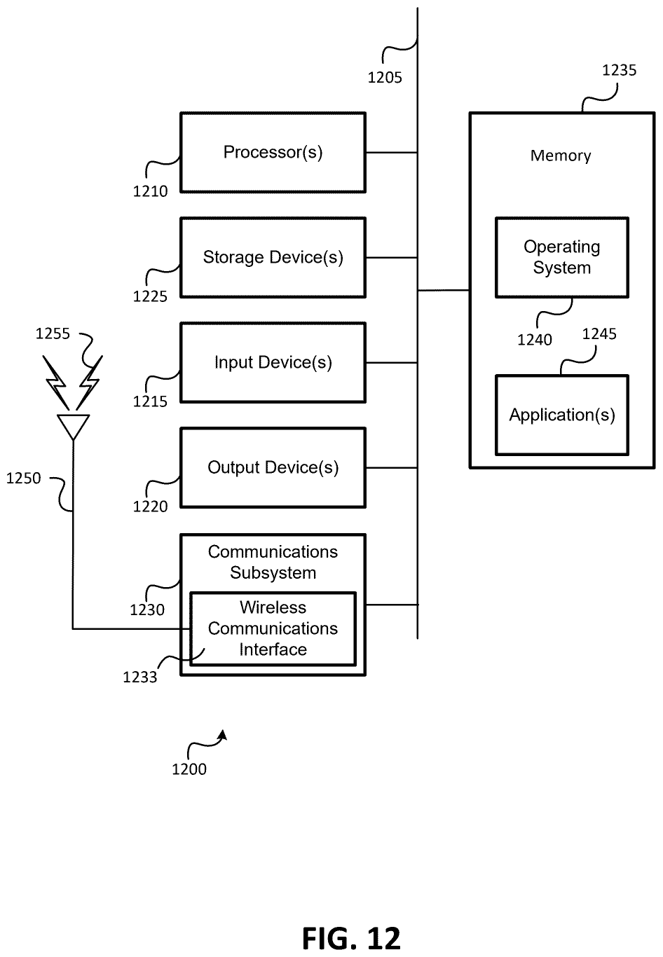

FIG. 12 is a block diagram of an embodiment of a computer system 1200, which may be used, in whole or in part, to provide the functions of one or more components and/or devices as described in the embodiments herein, including a server (e.g., sensing server/SMF and/or cluster head) in communication with one or more sensing nodes to coordinate RF sensing as described in embodiments herein. This may include, for example, a computer server, personal computer, personal electronic device, or the like. It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processor(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may comprise one or more wireless transceivers that may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including a User Equipment (UE), base stations and/or other transmission reception points (TRPs), and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of enabling pairing of a first sensing node and a second sensing node for radio frequency (RF) sensing, the method comprising: operating the first sensing node in a Tx detection mode in which the first sensing node: periodically transmits instances of a first reference signal (RS), and periodically attempts to receive instances of a second RS transmitted by the second sensing node; and responsive to detecting a target with a received instance of the second RS transmitted by the second sensing node, transitioning operation of the first sensing node from the Tx detection mode to a Tx tracking mode in which the first sensing node: periodically transmits instances of a third RS, and periodically attempts to receive additional instances of the second RS transmitted by the second sensing node.

Clause 2. The method of clause 1, wherein the periodic transmission of the instances of the first RS, the periodic attempted reception of the instances of the second RS, the periodic transmission of the instances of the third RS, or any combination thereof, are in accordance with a configuration received by the first sensing node from a server.

Clause 3. The method of any one of clauses 1-2, further comprising transitioning the operation of the first sensing node from the Tx tracking mode back to the Tx detection mode, wherein transitioning the operation of the first sensing node back to the Tx detection mode is responsive to: the first sensing node not detecting the target with a received additional instance of the second RS transmitted by the second sensing node, or the first sensing node not receiving an additional instance of the second RS transmitted by the second sensing node.

Clause 4. The method of any one of clauses 1-3, wherein the first sensing node periodically transmits the instances of the third RS in the Tx tracking mode at a higher repetition rate than a repetition rate at which the first sensing node periodically transmits the instances of the first RS in the Tx detection mode.

Clause 5. The method of any one of clauses 1-4, wherein, responsive to receiving a particular instance of the second RS transmitted by the second sensing node without detecting the target with the particular instance of the second RS, the first sensing node pauses the periodic transmission of the instances of the first RS while operating in the Tx detection mode.

Clause 6. The method of any one of clauses 1-5, wherein the first sensing node periodically transmits the instances of the first RS in the Tx tracking mode at a higher repetition rate than a repetition rate at which the first sensing node periodically attempts to receive the instances of the second RS transmitted by the second sensing node.

Clause 7. The method of any of clauses 1-6, wherein the first RS and the second RS are selected from a common RS pool.

Clause 8. The method of any one of clauses 1-7, further comprising: obtaining sensing data from the received instance of the second RS transmitted by the second sensing node; and sending the sensing data from the first sensing node to a server.

Clause 9. The method of clause 8, wherein the sensing data further comprises information indicative of: a range between the target and the first sensing node, a signal-to-noise ratio (SNR) of the received instance of the second RS transmitted by the second sensing node, Doppler information regarding the target, or any combination thereof.

Clause 10. A method of enabling pairing of a first sensing node and a second sensing node for radio frequency (RF) sensing, the method comprising: operating the second sensing node in an Rx detection mode in which the second sensing node periodically attempts to receive instances of a first reference signal (RS) transmitted by the first sensing node; and responsive to detecting a target with a received instance of the first RS transmitted by the first sensing node, transitioning operation of the second sensing node from the Rx detection mode to an Rx tracking mode in which the second sensing node: periodically transmits instances of a second RS, and periodically attempts to receive instances of a third RS transmitted by the first sensing node.

Clause 11. The method of clause 10, wherein the periodic attempted reception of the instances of the first RS transmitted by the first sensing node, the periodic transmission of the instances of the third RS, the periodic attempted reception of the instances of the third RS transmitted by the first sensing node, or any combination thereof, are in accordance with a configuration received by the second sensing node from a server.

Clause 12. The method of any one of clauses 10-11, further comprising transitioning the operation of the second sensing node from the Rx tracking mode back to the Rx detection mode, wherein transitioning the operation of the first sensing node back to the Rx detection mode is responsive to: the second sensing node not detecting the target with a received instance of the third RS transmitted by the first sensing node, or the second sensing node not receiving an instance of the third RS transmitted by the first sensing node.

Clause 13. The method of any one of clauses 10-12, wherein the second sensing node periodically attempts to receive the instances of the third RS transmitted by the first sensing node at a higher repetition rate than a repetition rate at which the second sensing node periodically attempts to receive the instances of the first RS transmitted by the first sensing node.

Clause 14. The method of any one of clauses 10-13, wherein the second sensing node periodically attempts to receive the instances of the first RS transmitted by the first sensing node at a higher repetition rate than a repetition rate at which the first sensing node periodically transmits the instances of the second RS.

Clause 15. The method of any one of clauses 10-14, wherein the first RS and the second RS are selected from a common RS pool.

Clause 16. The method of any one of clauses 10-15, further comprising: obtaining sensing data from a received instance of the third RS transmitted by the first sensing node; and sending the sensing data from the second sensing node to a server.

Clause 17. The method of clause 16, wherein the sensing data further comprises information indicative of: a range between the target and the second sensing node, a signal-to-noise ratio (SNR) of the received instance of the third RS transmitted by the first sensing node, Doppler information regarding the target, or any combination thereof.

Clause 18. A first sensing node for radio frequency (RF) sensing, the first sensing node comprising: a transceiver; a memory; and one or more processors communicatively coupled with the transceiver and the memory, wherein the one or more processors are configured to: operate in a Tx detection mode in which the first sensing node: periodically transmits instances of a first reference signal (RS) via the transceiver, and periodically attempts to receive, via the transceiver, instances of a second RS transmitted by a second sensing node; and responsive to detecting a target with a received instance of the second RS transmitted by the second sensing node, transition operation from the Tx detection mode to a Tx tracking mode in which the first sensing node: periodically transmits instances of a third RS via the transceiver, and periodically attempts to receive, via the transceiver, additional instances of the second RS transmitted by the second sensing node.

Clause 19. The first sensing node of clause 18, wherein the one or more processors are configured to periodically transmit the instances of the first RS, periodically attempt to receive of the instances of the second RS, periodically transmit the instances of the third RS, or any combination thereof, in accordance with a configuration received by the first sensing node from a server.

Clause 20. The first sensing node of any of clauses 18-19, wherein the one or more processors are configured to transition from the Tx tracking mode back to the Tx detection mode, responsive to: not detecting the target with a received additional instance of the second RS transmitted by the second sensing node, or not receiving an additional instance of the second RS transmitted by the second sensing node.

Clause 21. The first sensing node of any of clauses 18-20, wherein the one or more processors are configured to periodically transmit the instances of the third RS in the Tx tracking mode at a higher repetition rate than a repetition rate at which the one or more processors are configured to periodically transmit the instances of the first RS in the Tx detection mode.

Clause 22. The first sensing node of any of clauses 18-21, wherein the one or more processors are configured to, responsive to receiving a particular instance of the second RS transmitted by the second sensing node without detecting the target with the particular instance of the second RS, pause the periodic transmission of the instances of the first RS while operating in the Tx detection mode.

Clause 23. The first sensing node of any of clauses 18-22, wherein the one or more processors are configured to periodically transmit the instances of the first RS in the Tx tracking mode at a higher repetition rate than a repetition rate at which the one or more processors are configured to periodically attempt to receive the instances of the second RS transmitted by the second sensing node.

Clause 24. The first sensing node of any of clauses 18-23, wherein the first RS and the second RS are selected from a common RS pool.

Clause 25. The first sensing node of any of clauses 18-24, wherein the one or more processors are further configured to: obtain sensing data from the received instance of the second RS transmitted by the second sensing node; and send the sensing data from the first sensing node to a server.

Clause 26. A second sensing node for radio frequency (RF) sensing, the second sensing node comprising: a transceiver; a memory; and one or more processors communicatively coupled with the transceiver and the memory, wherein the one or more processors are configured to: operate in an Rx detection mode in which the second sensing node periodically attempts to receive instances of a first reference signal (RS) transmitted by the first sensing node; and responsive to detecting a target with a received instance of the first RS transmitted by the first sensing node, transition operation from the Rx detection mode to an Rx tracking mode in which the second sensing node: periodically transmits instances of a second RS, and periodically attempts to receive instances of a third RS transmitted by the first sensing node.

Clause 27. The second sensing node of clause 26, wherein the one or more processors are configured to periodically attempt to receive the instances of the first RS transmitted by the first sensing node, periodically transmit the instances of the third RS, periodically attempt to receive the instances of the third RS transmitted by the first sensing node, or any combination thereof, in accordance with a configuration received by the second sensing node from a server.

Clause 28. The second sensing node of any of clauses 26-27, wherein the one or more processors are further configured to transition the operation from the Rx tracking mode back to the Rx detection mode, responsive to: not detecting the target with a received instance of the third RS transmitted by the first sensing node, or not receiving an instance of the third RS transmitted by the first sensing node.

Clause 29. The second sensing node of any of clauses 26-28, wherein the one or more processors are configured to periodically attempt to receive the instances of the third RS transmitted by the first sensing node at a higher repetition rate than a repetition rate at which the one or more processors are configured to periodically attempt to receive the instances of the first RS transmitted by the first sensing node.

Clause 30. The second sensing node of any of clauses 26-29, wherein the one or more processors are configured to periodically attempt to receive the instances of the first RS transmitted by the first sensing node at a higher repetition rate than a repetition rate at which the one or more processors are configured to periodically transmit the instances of the second RS.

Clause 31. An apparatus having means for performing the method of any one of clauses 1-17.

Clause 32. A non-transitory computer-readable medium storing instructions, the instructions comprising code for performing the method of any one of clauses 1-17.

1. A method of enabling pairing of a first sensing node and a second sensing node for radio frequency (RF) sensing, the method comprising:
operating the first sensing node in a Tx detection mode in which the first sensing node:
periodically transmits instances of a first reference signal (RS), and periodically attempts to receive instances of a second RS transmitted by the second sensing node; and
responsive to detecting a target with a received instance of the second RS transmitted by the second sensing node, transitioning operation of the first sensing node from the Tx detection mode to a Tx tracking mode in which the first sensing node:
periodically transmits instances of a third RS, and
periodically attempts to receive additional instances of the second RS transmitted by the second sensing node.

2-4. (canceled)

5. The method of claim 1, wherein, responsive to receiving a particular instance of the second RS transmitted by the second sensing node without detecting the target with the particular instance of the second RS, the first sensing node pauses the periodic transmission of the instances of the first RS while operating in the Tx detection mode.

6. (canceled)

7. The method of claim 1, wherein the first RS and the second RS are selected from a common RS pool.

8-9. (canceled)

10. A method of enabling pairing of a first sensing node and a second sensing node for radio frequency (RF) sensing, the method comprising:
operating the second sensing node in an Rx detection mode in which the second sensing node periodically attempts to receive instances of a first reference signal (RS) transmitted by the first sensing node; and
responsive to detecting a target with a received instance of the first RS transmitted by the first sensing node, transitioning operation of the second sensing node from the Rx detection mode to an Rx tracking mode in which the second sensing node:
periodically transmits instances of a second RS, and
periodically attempts to receive instances of a third RS transmitted by the first sensing node.

11-14. (canceled)

15. The method of claim 10, wherein the first RS and the second RS are selected from a common RS pool.

16. The method of claim 10, further comprising:
obtaining sensing data from a received instance of the third RS transmitted by the first sensing node; and
sending the sensing data from the second sensing node to a server.

17. The method of claim 16, wherein the sensing data further comprises information indicative of:
a range between the target and the second sensing node,
a signal-to-noise ratio (SNR) of the received instance of the third RS transmitted by the first sensing node,
Doppler information regarding the target, or
any combination thereof.

18. A first sensing node for radio frequency (RF) sensing, the first sensing node comprising:
a transceiver;
a memory; and
one or more processors communicatively coupled with the transceiver and the memory, wherein the one or more processors are configured to:
operate in a Tx detection mode in which the first sensing node:
periodically transmits instances of a first reference signal (RS) via the transceiver, and
periodically attempts to receive, via the transceiver, instances of a second RS transmitted by a second sensing node; and
responsive to detecting a target with a received instance of the second RS transmitted by the second sensing node, transition operation from the Tx detection mode to a Tx tracking mode in which the first sensing node:
periodically transmits instances of a third RS via the transceiver, and
periodically attempts to receive, via the transceiver, additional instances of the second RS transmitted by the second sensing node.

19. The first sensing node of claim 18, wherein the one or more processors are configured to periodically transmit the instances of the first RS, periodically attempt to receive of the instances of the second RS, periodically transmit the instances of the third RS, or any combination thereof, in accordance with a configuration received by the first sensing node from a server.

20. The first sensing node of claim 18, wherein the one or more processors are configured to transition from the Tx tracking mode back to the Tx detection mode, responsive to:
not detecting the target with a received additional instance of the second RS transmitted by the second sensing node, or
not receiving an additional instance of the second RS transmitted by the second sensing node.

21. The first sensing node of claim 18, wherein the one or more processors are configured to periodically transmit the instances of the third RS in the Tx tracking mode at a higher repetition rate than a repetition rate at which the one or more processors are configured to periodically transmit the instances of the first RS in the Tx detection mode.

22. The first sensing node of claim 18, wherein the one or more processors are configured to, responsive to receiving a particular instance of the second RS transmitted by the second sensing node without detecting the target with the particular instance of the second RS, pause the periodic transmission of the instances of the first RS while operating in the Tx detection mode.

23. The first sensing node of claim 18, wherein the one or more processors are configured to periodically transmit the instances of the first RS in the Tx tracking mode at a higher repetition rate than a repetition rate at which the one or more processors are configured to periodically attempt to receive the instances of the second RS transmitted by the second sensing node.

24. The first sensing node of claim 18, wherein the first RS and the second RS are selected from a common RS pool.

25. The first sensing node of claim 18, wherein the one or more processors are further configured to:
obtain sensing data from the received instance of the second RS transmitted by the second sensing node; and
send the sensing data from the first sensing node to a server.

26. A second sensing node for radio frequency (RF) sensing, the second sensing node comprising:
a transceiver;
a memory; and
one or more processors communicatively coupled with the transceiver and the memory, wherein the one or more processors are configured to:
operate in an Rx detection mode in which the second sensing node periodically attempts to receive instances of a first reference signal (RS) transmitted by the first sensing node; and
responsive to detecting a target with a received instance of the first RS transmitted by the first sensing node, transition operation from the Rx detection mode to an Rx tracking mode in which the second sensing node:
periodically transmits instances of a second RS, and
periodically attempts to receive instances of a third RS transmitted by the first sensing node.

27. The second sensing node of claim 26, wherein the one or more processors are configured to periodically attempt to receive the instances of the first RS transmitted by the first sensing node, periodically transmit the instances of the third RS, periodically attempt to receive the instances of the third RS transmitted by the first sensing node, or any combination thereof, in accordance with a configuration received by the second sensing node from a server.

28. The second sensing node of claim 26, wherein the one or more processors are further configured to transition the operation from the Rx tracking mode back to the Rx detection mode, responsive to:
not detecting the target with a received instance of the third RS transmitted by the first sensing node, or
not receiving an instance of the third RS transmitted by the first sensing node.

29. The second sensing node of claim 26, wherein the one or more processors are configured to periodically attempt to receive the instances of the third RS transmitted by the first sensing node at a higher repetition rate than a repetition rate at which the one or more processors are configured to periodically attempt to receive the instances of the first RS transmitted by the first sensing node.

30. The second sensing node of claim 26, wherein the one or more processors are configured to periodically attempt to receive the instances of the first RS transmitted by the first sensing node at a higher repetition rate than a repetition rate at which the one or more processors are configured to periodically transmit the instances of the second RS.
